(19) United States
(12) Patent Application Publication
(10) Pub. No.: US 2023/0292835 A1
(43) Pub. Date: Sep. 21, 2023

(54) An Aerosol Generating System and a Liquid Substance Storing Container for Such an Aerosol Generating System

(71) Applicant: JT International S.A., Geneva (CH)

(72) Inventors: Broderick Coburn, Mont Sur Rolle (CH); Joao Seco, Geneva (CH)

(73) Assignee: JT International SA, Geneva (CH)

(21) Appl. No.: 18/026,507

(22) PCT Filed: Oct. 1, 2021
(86) PCT No.: PCT/EP2021/077161

§ 371 Date: Mar. 15, 2023

(30) Foreign Application Priority Data
Oct. 5, 2020 (EP) 20200075.8

(51) Int. Cl. A24F 40/42; A24F 40/10; A24F 40/46; A24F 7/00; H05B 3/42

(52) U.S. Cl. CPC A24F 40/42; A24F 7/00; A24F 40/10; A24F 40/46; H05B 3/42; H05B 2203/021

(57) ABSTRACT

An aerosol generating system includes a liquid substance storing container and an aerosol generating device such as a e-cigarette. The liquid substance storing container includes a porous body for storing liquid substance, and the aerosol generating device includes a heating element configured to fit into a hole of the porous body. The hole is tapered or frusto-conical, and the heating element has external surfaces tapered to match the internal surfaces of the tapered or frusto-conical hole.

### FIELD OF THE INVENTION

The present invention relates to an aerosol generating system.

It also concerns a liquid substance storing container for such an aerosol generating system.

### BACKGROUND OF THE INVENTION

Aerosol generating devices, also commonly called vaporizers or electronic cigarettes, allow vaporization of a substance to create an aerosol or mist that a user inhales.

An aerosol generating device comprises a heat source that heats the substance, generally a liquid often called e-liquid or e-juice, to create the aerosol in a vaporization zone of the aerosol generating device. Channels are also provided for routing the aerosol from the vaporization zone to a mouth piece for the user.

The aerosol generating device often comprises a reservoir configured for storing the substance in liquid form, and feeders configured for moving the substance from the reservoir, such as by wicking or capillary action, to a vaporization zone for heating or vaporization.

This type of configuration needs to provide sealing means to seal a liquid outlet hole on the reservoir.

In order to avoid the drawbacks of a reservoir, such as liquid leakages, US 2018/0289909 discloses a vaporizer adapted to vaporize oil that is stored in one or several tabs.

The tab, such as a tablet, cylinder, or disk, can include a porous body for storing liquid substance. For example, the tab can include a piece of porous ceramic or sintered metal soaked, injected or infused with oil, such as to the point that the oil is held in place by capillary action. Such a tab provides a medium for storing, transporting and allowing vaporization of a substance.

In such an example, the vaporizer can include a reservoir configured for holding one or more tabs and for supporting the tabs during heating.

Thus, each tab is heated by a heating element of the vaporizer. The heating element may be a laser, a resistance heater, a wire or a coil for example, disposed in a housing of the aerosol generating device in order to heat the tab by contact or via a medium (air for example) heated by the heating element.

The present invention aims to improve the thermal efficiency of an aerosol generating system when heating a liquid substance storing container comprising a porous body for storing a liquid substance.

### SUMMARY OF THE INVENTION

The present invention thus relates to an aerosol generating system comprising a liquid substance storing container and an aerosol generating device, the liquid substance storing container comprising a porous body for storing liquid substance and the aerosol generating device comprising a heating element configured to fit into a hole of said porous body.

According to one aspect of the invention, the hole is tapered or frustoconical, the heating element having external surfaces tapered to match the internal surfaces of said tapered or frusto-conical hole.

Thus, the heating element has external surfaces configured to match internal surfaces of said hole of the porous body.

As a consequence, the cooperation of the storing container with the heating element of the aerosol generating device is increased such as the transfer of heat from the heating element to the porous body. Such a heating through a hole of the porous body improves the transfer of heat to the liquid substance storing container, in order to speed up the temperature rise in the porous body, and thus the vaporization of the liquid substance.

Thus, thanks to the tapered or frusto-conical hole, the exchange surface between the hole and the heating element may be increased compared to a cylindrical hole. In practice, the heating element is in contact with at least one internal surface of said hole for conducting heat to the porous body.

The contact between the heating element and at least one internal surface of said hole improves the positioning and maintaining in position of the heating element in contact with the porous body.

According to another aspect, the aerosol generating device comprises a mouth piece in contact with the porous body, said porous body being compressed between said mouth piece and said heating element fitted into the hole of the porous body.

As a consequence, the heating element is constantly in contact with the porous body with an optimized backlash. Such a compression improves the transfer of heat from the heating element to the porous body, in order to speed up the temperature rise of the porous body, whatever is the shape of the hole of the porous body.

According to one embodiment, the porous body is adapted to release a vaporized liquid substance when said porous body is heated by the heating element at or above a threshold temperature of 50° C.

According to another aspect, the present invention relates to a liquid substance storing container for an aerosol generating system as recited above, wherein the porous body is configured to retain the liquid substance in an ambient temperature and to release and vaporize said liquid substance when heated to form an aerosol.

Thus, the storing container is well adapted to store a liquid substance before its heating and vaporization. The storing container may be manipulated by a user without risk of leakage, before using in an aerosol generating device.

According to one embodiment, the porous body is adapted to absorb a volume of liquid substance and to retain said volume of liquid substance until vaporized.

The liquid substance is absorbed by capillary action in the porous body in order to be stored therein. The volume of liquid substance is then retained in walls of the porous body until a threshold temperature, when the liquid substance is vaporized.

In practice, the hole of the porous body substantially extends along a central axis of the porous body.

The heat is uniformly transferred from the heating element through the porous body in any direction around the central axis of the porous body.

In one embodiment, the porous body includes a closed internal cavity, said closed internal cavity further storing liquid substance.

Thus, the volume of stored liquid substance in the storing container may be increased compared to a storing container made of the same porous body, without a closed internal cavity.

Indeed, the volume of stored liquid substance is not limited to the volume of the liquid substance which can be stored in the pores of the porous body of the tab, but also comprises the volume of the liquid substance stored in the closed internal cavity.

The packing efficiency is thus improved compared to a storing container made of a homogenous porous body with no internal cavity.

As an example, the porous body is made of porous ceramic, sintered metal, sintered glass or alumina.

In one configuration, the porous body has a shape of a hollow disk, a hollow cylinder or a hollow truncated cone.

The hollow form of the porous body may facilitate the handling of the storing container and/or the cooperation of the storing container with the heating unit in the aerosol generating device.

### BRIEF DESCRIPTION OF THE DRAWINGS

Other particularities and advantages of the invention will also emerge from the following description.

In the accompanying drawings, given by way of non-limiting examples:

FIG. 1 represents, in a schematic front view, an aerosol generating system according to a first embodiment of the invention;

FIG. 2A represents, in a three-dimensional view, a liquid substance storing container and a heating element of FIG. 1;

FIG. 2B represents, in a schematic sectional view, the liquid substance storing container and the heating element of FIG. 2A;

FIG. 2C represents, in a schematic sectional view, the liquid substance storing container and the heating element of FIG. 2A in an alternative embodiment;

FIG. 3 represents, in a schematic three dimensional view, a liquid substance storing container and a heating element according to another implementation;

FIG. 4A represents, in a three-dimensional view, a liquid substance storing container and a heating element according to an alternative implementation;

FIG. 4B represents, in a schematic sectional view, the liquid substance storing container and the heating element of FIG. 4A; and

FIG. 5 is a schematic view of a liquid substance storing container according to another embodiment of the invention.

### DETAILED DESCRIPTION

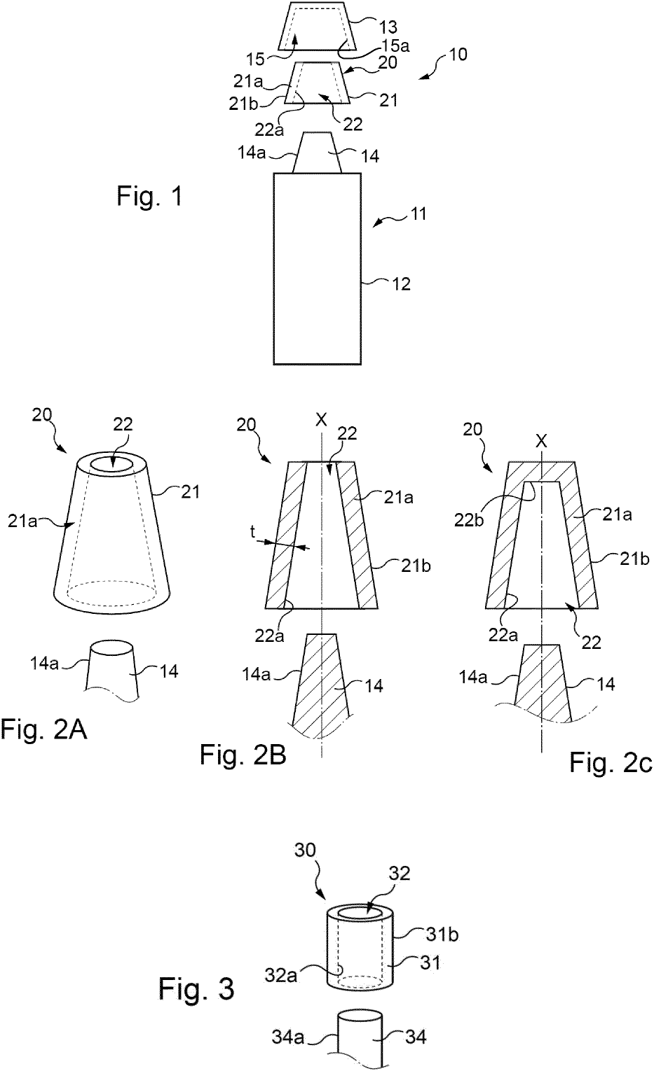

FIGS. 1, 2A and 2B depict an aerosol generating system according to a first embodiment.

The aerosol generating system 10 comprises an aerosol generating device 11.

The aerosol generating device 11 comprises as usual a housing 12 with a mouth piece 13 at one end for inhalation of a vapour or a mist by a user.

The aerosol generating system 10 also comprises a liquid substance storing container 20.

It should be noted that liquid substance storing container is a consumable item, configured to be used with an aerosol generating device, such as an electronic cigarette (e-cigarette). Once the liquid substance initially retained in the storing container has been aerolized and thus consumed, the storing container may be replaced by another liquid substance storing container. The old storing container can be discarded, preferably for recycling.

In the following, the liquid substance encompasses any types of vaporizable substances including oil, water, ..., which may be vaporized to form a mist capable of being inhaled by a user.

As an example, the liquid substance may be a e-liquid well known for using in the e-cigarettes. Extracts from the cannabis plant can also take the form of an oil or oil-like substance.

The liquid substance storing container 20 comprises a porous body 21 for storing the liquid substance.

The porous body 21 may be made of porous ceramic, sintered metal, sintered glass, aluminia or silicon carbide. Thus, the porous body 21 has a rigid or non-deformable structure.

The porous body 21 has an open-cell structure, with a matrix of pores adapted to absorb and then to retain, by capillary action, the liquid substance until vaporized.

Thanks to its porosity, the porous body 21 may absorb a volume of liquid substance, for example by infusing: the porous body is immersed in a liquid bath and the liquid is sucked into the pores of the porous body 21 by capillary action.

The aerosol generating device 11 also comprises a heating element or heater 14 adapted to heat the liquid substance storing container 20.

As depicted in FIG. 1, the heating element 14 is configured to fit into a hole 22 of the porous body 21 of the liquid substance storing container 20. Thus, the heater 14 and the liquid substance storing container 20 are distinct elements that can be assembled and separated.

In particular, the heater 14 is in contact with at least one internal surface 22a of the hole 22 for conducting heat to the porous body 21.

Thus, the heater 14 transfers thermal energy to the porous body 21 mainly by conduction.

The heater 14 can include or can be an electrical resistance heating element.

For example, in some implementations the electrical resistance heating element comprises a resistance metal wire or ribbon. In various implementations, the resistance metal wire or ribbon may be encased in a material to improve durability.

Moreover, the encasing of the resistance metal wire or ribbon serves as a contact surface with the hole 22 of the porous body 21. Preferably, the encasing is made of ceramic.

The heater 14 is preferably constructed of one or more conductive materials, including, but not limited to, nichrome alloy or kanthal, or a combination thereof.

The heater 14 protrudes from an end of the aerosol generating device 11.

Preferably, the heater 14 has external surfaces 14a configured to match internal surfaces 22a of the hole 22 of the porous body 21.

When the porous body 21 is fitted on the heater 14, the internal surfaces 22a of the hole 22 are in contact with the external surfaces 14a of the heater 14.

Thus, the transfer of heat to the porous body 21 is increased, and is not limited to one external surface of a porous body without hole.

As illustrated in the following Figures, and in a preferred embodiment, the hole 22 is a through-hole in the porous body 21.

The heater 14 is projecting into the through-hole, along a central longitudinal axis X of the hole 22.

Thus, the internal surfaces 22a of the hole 22 correspond to the radial surfaces of the hole 22.

The external surfaces 14a of the heater 14 are in contact with at least part of the internal surfaces 22a of the hole 22.

Preferably, the heating element 14 and the hole 22 of the porous body 21 have slightly the same dimensions.

For example, the diameter of the hole 22 of the porous body 21 may range from about 2 to 5 mm.

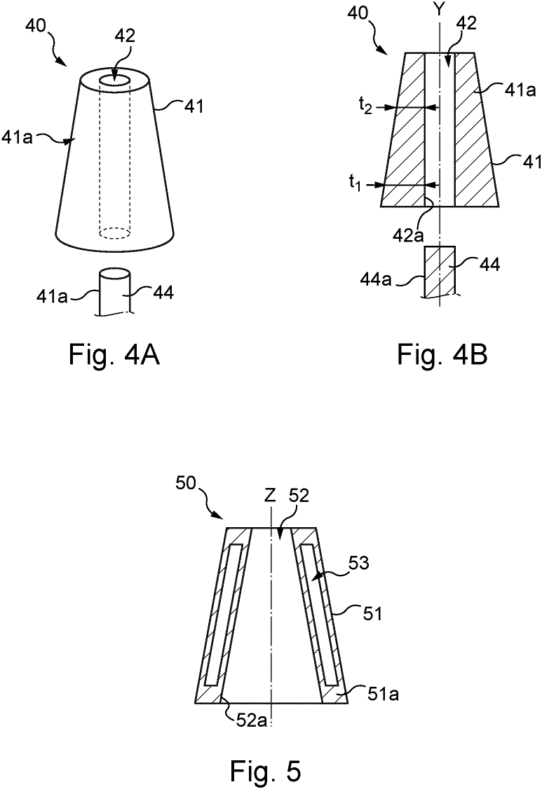

In some implementations as depicted in FIGS. 3, 4A and 4B, the hole 22 may have an essentially constant diameter along its length.

As described below in relation with FIGS. 1, 2A to 2C and 5, the hole 22 may have a variable diameter, which increases or decreases along its central longitudinal axis.

Of course, the configuration of the hole 22 is not limitative. In particular, the hole 22 of the porous body 21 may also be a blind hole, with a through-opening adapted to receive the heater 14, as described hereinafter.

Thus, the internal surfaces 22a of the hole 22 correspond in this case to the radial surfaces and to the bottom surface of the hole 22.

The surfaces of the heater 14 and the porous body 21 in contact to each other are increased.

Thus, the temperature rise in the porous body 21 is increased, and then the vaporization of the liquid substance.

Thanks to the protruding form of the heater 14, the porous body may be held in position by fitting the heater into the hole 22 of the porous body 21.

In this embodiment, and as described below, the porous body 21 is compressed between the mouth piece 13 and the heating element 14 which fits into the hole 22 of the porous body 21.

As illustrated in FIG. 1, the mouth piece 13 has an opened cavity 15 adapted to fit with the porous body 21 of the liquid substance storing container 20.

More precisely, the cavity 15 of the mouth piece 13 has inner surfaces 15a configured to fit with external surfaces 21b of the porous body 21.

For assembly concerns, the mouth piece 13 is removably mounted on the aerosol generating device 11.

The mouth piece 13 is adapted to be in contact with the porous body 21 and with the aerosol generating device 11 at the same end of the heater 14.

The mouth piece 13 is removably fixed by fixing element (not shown) to the end of the aerosol generating device 11.

Preferably, the opened cavity 15 has the same or slightly smaller dimensions than the one of the porous body 21 in order to compress the porous body 21 between the mouth piece 13 and the heater 14, when the mouth piece 13 is fixed to the aerosol generating device.

More precisely, the porous body 21 is compressed between the inner surfaces 15a of the mouth piece 13 and the external surfaces 14a of the heating element 14.

Even more precisely, at least part of the external surfaces 21b of the porous body 21 is in contact with at least part of the inner surfaces 15a of the mouth piece 13 and at least part of the internal surfaces 22a of the porous body 21 is in contact with at least part of the external surfaces 14a of the heating element 14.

Thus the mouth piece 13 is fixed on the aerosol generating device 11 in order to reduce the backlash between the internal surfaces 22a of the hole 22 of the porous body 21 and the external surfaces 14a of the heater 14.

Accordingly, the transfer of heat by conduction from the heater 14 to the porous body 21 is increased by reducing the thermal resistance.

This is true for the different porous bodies described in the following description and represented on FIGS. 1 to 5.

In this first embodiment, the porous body 21 takes a shape of a hollow truncated cone, with a central longitudinal axis X.

The porous body 21 has overall dimensions preferably smaller about a 20 mm by 20 mm by 10 mm box and more preferably of about a 10 mm by 10 mm by 5 mm box. On the contrary, the porous body 21 has overall dimensions preferably larger about a cylinder with diameter of about 5 mm and a height of about 3 mm.

As illustrated in FIGS. 2A and 2B, the hole 22 of the porous body 21 extends along the longitudinal axis X of the porous body 21.

The hole 22 takes in this embodiment a tapered or frusto-conical shape, centrally disposed in the porous body 21.

In this embodiment, the hole 22 has, at the ends of the porous body 21, a smaller diameter preferably of about 2 mm or more and a larger diameter preferably of about 5 mm or less.

Thus, the shape of the hole 22 is concentric with the shape of the porous body 21.

Accordingly, the porous body 21 forms side walls 21a surrounding the hole 22. The side walls 21a have a thickness t representing the distance between the internal surfaces 22a and an external surface 21b of the porous body 21.

The thickness t of the walls 21a of the porous body 21 surrounding the hole 22 is thus identical in any directions around the central longitudinal axis X.

In this embodiment, the thickness t of the side walls 21a of the porous body 21 is the same.

For example, the thickness t is preferably about 0.5 to 10 mm and more preferably about 2 to 5 mm.

The heating element 14 is configured to fit with the hole 22 of the porous body 21.

The heating element 14 has external surfaces 14a tapered to match the internal surfaces 22a of the tapered or frusto-conical hole 22.

When the heating element 14 fits with the porous body 21, the tapered or frusto-conical shape of heating element 14 has the same central longitudinal axis X as the one of the tapered or frusto-conical shape of the hole 22, and the centres of the tapered or frusto-conical shapes of the heating element 14 and the hole 22 are merged.

Of course, the shapes of the heating element 14, the porous body 21 and the hole 22 are not limitative. As an alternative, represented in FIG. 2C, the hole 22 is a blind hole. The blind hole 22 is preferably opened onto the axial end of the porous body 21 having the largest diameter. The protruding end of the heater 14 is in contact with the bottom 22b of the blind hole 22 when the heater 14 is fitted in the blind hole 22 of the porous body 21. The distance between the bottom 22b of the hole 22 and the external surfaces 21b in direction of the central longitudinal axis X is preferably equal to the thickness of side walls 21a of the porous body 21.

As depicted in FIG. 3, as an example of implementation, the porous body 31 of the liquid substance storing container 30 may also take the shape of a hollow disk or a hollow cylinder or another shape, the hole 32 taking a same homothetic shape of a cylinder.

The hole 32 is centrally disposed on the porous body 31. Preferably, the hole 32 is concentric the porous body 31.

The heating element 34 has also a shape of a cylinder, adapted to fit with the cylindrical shape of the hole 32 of the porous body 31.

Thus, the hole 32 has an essentially constant diameter along its length, preferably ranging from about 2 to 5 mm.

The heating element 34 as described above has external surfaces 34a configured to match the internal surfaces 32a of the cylindrical hole 32.

As illustrated in first and second embodiments, the hole 22, 32 has a three-dimensional shape homothetic to the shape of the porous body 21, 31.

Of course, the shapes of the porous body 21, 31 and the hole 22, 32 are not limitative.

In particular, the hole 22, 32 may also be non-homothetic to the shape of the porous body 21, 31 and/or be non-concentric with the shape of the porous body 21, 31.

As illustrated in FIGS. 4A and 4B, in an alternative implementation, the porous body 41 has the same shape of truncated cone that the porous body 21 with a central longitudinal axis Y while the hole 42 of the porous body 41 takes the shape of a cylinder.

As illustrated in FIG. 4B, the hole 42 of the porous body 41 extends along the longitudinal axis Y of the porous body 41.

In this embodiment, the hole 42 has the same diameter as the hole 32 represented in FIG. 3.

Thus, the shape of the hole 42 is concentric with the shape of the porous body 41.

The heating element 44 has the same shape of cylinder that the hole 32, adapted to fit with the cylindrical shape of the hole 42 of the porous body 41.

The heating element 44 as described above has external surfaces 44a configured to match the internal surfaces 42a of the cylindrical hole 42.

As described above, the porous body 41 forms side walls 41a surrounding the hole 42.

The side walls 41a have here a variable thickness depending on the longitudinal position along the axis Y.

For example, the walls 41a of the porous body 41 surrounding the hole 42 have a thickness t1 at one point near the base of the truncated cone. The walls 41a of the porous body 41 have a different thickness t2 at one point near the top of the truncated cone.

In this alternative implementation, the thickness t1 is greater than the thickness t2. More generally, the thickness increases from the top to the base of the truncated cone.

For example, the thickness t1 is preferably about 2 to 10 mm and the thickness t2 is preferably about 0.5 to 5 mm. The liquid substance storing container 20, 30, 40 as described here above forms a solid consumable comprising a porous body 21, 31, 41 configured to retain the liquid substrate at an ambient temperature and to release and vaporize the liquid substrate when heated to form an aerosol as described here above.

Thus, the porous body 21, 31, 41 resists egress or leakage of liquid substrate through the pores of the porous material absent heating and vaporization of the liquid substrate.

Thus, the porous body 21, 31, 41 also retain the liquid substance in a leak-proof manner when the porous body is maintained below a threshold temperature, and is not heated.

The threshold temperature is set for instance to 50° C., so that the liquid substance storing container 20, 30, 40 may be stored and transported without liquid leakage before use, by keeping the liquid substance storing container 20, 30, 40 at room or ambient temperature.

On the contrary, when the porous body 21, 31, 41 is heated at or above the threshold temperature, the open-cell structure of the porous body 21, 31, 41 is adapted to release, through its outer surface, a vaporized liquid substance.

More precisely, the liquid substance heated in the pores of the porous body 21, 31, is vaporized and released from the porous body 21, 31.

Thus the liquid substance exudes through the porous walls 21a, 31a, 41a only when the porous body 21, 31, 41 is heated via the heater 14, 34, 44 from the internal surfaces 22a, 32a, 42a above the threshold temperature.

By way of example illustrated in FIG. 5, the porous body 51 of a liquid substance storing container 50 may include a closed internal cavity 53.

Here, the porous body 51 has the same shape of truncated cone that the porous body 20 of the first embodiment, which extends along a central longitudinal axis Z.

It will be understood that a heater having the same shape of the heater 14 has external surfaces configured to match internal surfaces 52a of the hole 52 of the porous body 51.

The closed internal cavity 53 is thus a recess or a chamber enclosed by the walls 51a of the porous body 51.

The closed internal cavity 53 thus forms a closed pocket or reservoir in the porous body itself, for storing liquid substance.

The closed internal cavity 53 has also three-dimensional shape of truncated cone, disposed along the same longitudinal axis Z as the one of the porous body 51.

Preferably, the three-dimensional shape of the closed internal cavity 53 is concentric with the shape of the porous body 51.

Of course, the example given here below of a liquid substance storing container 50 is not limitative.

In particular, the closed internal cavity 53 may also be non-homothetic to the shape of the porous body 51 and/or be non-concentric with the shape of the porous body 51.

Thanks to the invention, an improved aerosol generating system may be provided, with a faster temperature rise compared to an aerosol generating system having the same power and a classic heater in contact or at proximity of a homogeneous porous body without hole.

Due to the improved matching shape of the tapered heater and the tapered porous body, lower power may be required, compared to a homogeneous porous body without hole or with cylindrical hole and classic heater for the same heat needs.

Alternatively, for a predetermined power of the aerosol generating device, a threshold temperature of the porous body may be reached faster thanks to the presence of the matching shape of the heater and the hole of the porous body.

1. An aerosol generating system comprising a liquid substance storing container and an aerosol generating device, said liquid substance storing container comprising a porous body for storing a liquid substance and said aerosol generating device comprising a heating element configured to fit into a hole of said porous body, wherein said hole is tapered or frusto-conical, said heating element having external surfaces tapered to match the-internal surfaces of said tapered or frusto-conical hole.

2. The aerosol generating system according to claim 1, wherein said heating element is in contact with at least one of the internal surfaces of said hole for conducting heat to the porous body.

3. The aerosol generating system according to claims 1, wherein said aerosol generating device further comprises a mouth piece in contact with the porous body, said porous body being compressed between said mouth piece and said heating element fitted into the hole of the porous body .

4. The aerosol generating system according to claims 1, wherein the porous body is adapted to release a vaporized liquid substance when said porous body is heated by the heating element at or above a threshold temperature of 50° C.

5. The aerosol generating system according to claims 1, wherein the porous body is configured to retain the liquid substance in an ambient temperature and to release and vaporize said liquid substance when heated to form an aerosol.

6. The aerosol generating system according to claim 5, wherein said porous body is adapted to absorb a volume of liquid substance and to retain said volume of liquid substance until vaporized.

7. The aerosol generating system according to claim 5, wherein said hole of the porous body substantially extends along a central axis of the porous body.

8. The aerosol generating system according to claim 5, wherein said porous body includes a closed internal cavity, said closed internal cavity further storing liquid substance.

9. The aerosol generating system according to claim 5, wherein said porous body is made of porous ceramic, sintered metal, sintered glass or alumina.

10. The aerosol generating system according to claim 5, wherein said porous body has a shape of a hollow disk, a hollow cylinder or a hollow truncated cone.
